(19) United States
(12) Patent Application Publication
(10) Pub. No.: US 2022/0019207 A1
(43) Pub. Date: Jan. 20, 2022

(54) METHOD AND SYSTEM FOR FACILITY MANAGEMENT BASED ON USER-DEFINED RULES

(71) Applicant: Facilio Inc., Lewes, DE (US)

(72) Inventors: Prabhu RAMACHANDRAN, Chennai (IN); Yogendrababu VENKATAPATHY, Chennai (IN); Rajavel SUBRAMANIAN, Chennai (IN); Shivaraj SELVANATHAN, Chennai (IN)

(73) Assignee: Facilio Inc., Lewes, DE (US)

(21) Appl. No.: 16/932,579

(22) Filed: Jul. 17, 2020

(51) Int. Cl. G05B 23/02; G06Q 10/00; G06Q 10/06; G06Q 50/16; G06N 20/00; G06N 5/02; G01D 21/02

(52) U.S. Cl. CPC G05B 23/0218; G06Q 10/20; G06Q 10/06311; G01D 21/02; G06Q 50/163; G06N 20/00; G06N 5/025; G06Q 10/06316

(57) ABSTRACT

The present disclosure provides a system for facility management based on user-defined rules. The system receives a first set of data. In addition, the system obtains one or more pre-defined set of rules. Further, the one or more pre-defined set of rules is obtained from a rules engine. Furthermore, the system analyses the first set of data based on the one or more pre-defined set of rules. Moreover, the system detects one or more faults in a plurality of sensors and a plurality of equipment. Also, the system executes a set of actions based on the detection of the one or more faults and analyzed first set of data. Also, the set of actions includes changing state of at least one of the plurality of equipment or prioritizing a maintenance task for fixing the one or more faults.

### TECHNICAL FIELD

The present invention relates to the field of facility management system and, in particular, relates to a method and system for facility management based on user-defined rules in real time.

### INTRODUCTION

With the advent in technological advancements over the past few decades, there has been an exponential rise in the number of large facilities. These facilities are big residential complexes, commercial offices, shopping centres and the like. These facilities include a facility management system configured to manage, monitor, and control various sensors and equipment installed in or around the facility or facility area. The facility management system includes a heating, ventilation, and air conditioning system (herein after HVAC), a safety system, an illumination system, a fire warning system, other systems capable of performing functionality of the facility. Currently, many facility management systems provide control of the facility. These systems require skilled persons to control and operate the facility management system. The facility management system is very complex to operate. Typically, these facilities includes are equipped with number of individual HVAC systems, number of independent lights. So, there is a need of an advanced system for monitoring individual systems connected to the facility management system. Furthermore, it is advantageous to have a governor system that can allow for easy control of the facility management system, as well as automatically adjust facilities offered by the facility.

### SUMMARY

In a first example, a computer-implemented method is provided. The computer-implemented method for providing management operations in a facility based on user-defined rules. The computer-implemented method includes a first step to receive a first set of data. In addition, the computer-implemented method includes a second step to obtain one or more pre-defined set of rules. Further, the computer-implemented method includes a third step to analyze the first set of data based on the one or more pre-defined set of rules. Furthermore, the computer-implemented method includes a forth step to detect one or more faults in the plurality of sensors and a plurality of equipment. Moreover, the computer-implemented method includes a fifth step to execute a set of actions based on the detection of the one or more faults and analyzed first set of data. The first set of data is received from a plurality of sensors installed at different locations in a facility and the plurality of equipment inside the facility. The one or more pre-defined set of rules are obtained from a rules engine. The rules engine stores the one or more pre-defined set of rules in a database. The first set of data are stored on the database in real time. The facility management system detects the one or more faults. The one or more faults are compared to the first set of data in real time based on one or more logical operations. In addition, the one or more logical operations include if condition, and, or, not, nor, nand. The facility management system executes the set of actions based on the detection of the one or more faults and analyzed first set of data. The set of actions includes changing state of at least one of the plurality of equipment or prioritizing a maintenance task for fixing the one or more faults. The maintenance task is assigned to a maintenance team in real time.

In an embodiment of the present disclosure, the first set of data includes environment data, safety system data, electrical system data, electronic system data. In addition, the environmental data comprises temperature, atmospheric pressure, precipitation, humidity, and air quality index.

In an embodiment of the present disclosure, the plurality of equipment includes heating ventilation and air conditioning, facility lighting, intercom system, power system, fire system, security system.

In an embodiment of the present disclosure, the computer-implemented method provides feedback to a user through a communication device. In addition, the communication device includes a smartphone, a laptop, a smart watch, a tablet, and a smart display.

In an embodiment of the present disclosure, the plurality of sensors include temperature sensor, smoke sensor, thermal sensor, motion sensor, proximity sensor, optical sensor, light sensor, panic sensor, fire alarm, air quality index sensor and humidity sensor.

In an embodiment of the present disclosure, the fault detection engine predicts an estimated maintenance time for the one or more faults in real time. In addition, the estimated maintenance time is predicted based on the past set of fault data.

In an embodiment of the present disclosure, the computer-implemented method includes a state identifier. In addition, the state identifier determines status of the fault detection engine.

In an embodiment of the present disclosure, the one or more pre-defined set of rules include predetermined parameters related to the facility. In addition, the predetermined parameters may include default temperature, default humidity, default air quality index, default lighting, and default air flow rate, default pressure, default VFD speed, default differential pressure, default vibration, default valve position.

In an embodiment of the present disclosure, the computer-implemented method includes user-defined rules. In addition, the user-defined rules are custom rules of the one or more pre-defined set of rules. Further, the one or more pre-defined set of rules can be optimized by the user in real time.

In an embodiment of the present disclosure, the user-defined rules are based on user inputs. In addition, the user inputs are recorded on the communication device in real time.

In an embodiment of the present disclosure, the facility management system determines probability of occurrence of the one or more faults. In addition facility management system determines and identifies the probability of occurrence of the one or more faults in the plurality of equipment based on past data associated with the plurality of equipment and displays to the user on the communication device.

In an embodiment of the present disclosure, the facility management system calculates impact of anomalous behavior of the plurality of equipment. In addition, the facility management system calculates the anomalous behavior of the plurality of equipment using the fault detection engine in real time in order to save energy.

In an embodiment of the present disclosure, the facility management system notifies the user in real time. In addition, the facility management system notifies the user to give command to control the plurality of equipment based on the user defined rules or anomalous behavior of the plurality of equipment.

In an embodiment of the present disclosure the facility management system activates one or more rules. In addition, the facility management system activates one or more rules among the one or more pre-defined set of rules based one or more on pre-requisite conditions in real time.

In a second example, a computer system is provided. The computer system includes one or more processors, and a memory. The memory is coupled to the one or more processors. The memory stores instructions. The memory is executed by the one or more processors. The execution of the memory causes the one or more processors to perform a method for providing management operations in a facility based on user-defined rules. The method includes a first step to receive a first set of data. In addition, the method includes a second step to obtain one or more pre-defined set of rules. Further, the method includes a third step to analyze the first set of data based on the one or more pre-defined set of rules. Furthermore, the method includes a fourth step to detect one or more faults in the plurality of sensors and a plurality of equipment. Moreover, the method includes a fifth step to execute a set of actions based on the detection of the one or more faults and analyzed first set of data. The first set of data is received from a plurality of sensors installed at different locations in a facility and the plurality of equipment inside the facility. The one or more pre-defined set of rules are obtained from a rules engine. The rules engine stores the one or more pre-defined set of rules in a database. The first set of data are stored on the database in real time. The facility management system detects the one or more faults. The one or more faults are compared to the first set of data in real time based on one or more logical operations. In addition, the one or more logical operations include if condition, and, or, not, nor, nand. The facility management system executes the set of actions based on the detection of the one or more faults and analyzed first set of data. The set of actions includes changing state of at least one of the plurality of equipment or prioritizing a maintenance task for fixing the one or more faults. The maintenance task is assigned to a maintenance team in real time.

In a third example, a non-transitory computer-readable storage medium is provided. The non-transitory computer-readable storage medium encodes computer executable instructions. The computer executable instructions are executed by at least one processor to perform a method for providing management operations in a facility based on user-defined rules. The method includes a first step to receive a first set of data. In addition, the method includes a second step to obtain one or more pre-defined set of rules. Further, the method includes a third step to analyze the first set of data based on the one or more pre-defined set of rules. Furthermore, the method includes a fourth step to detect one or more faults in the plurality of sensors and a plurality of equipment. Moreover, the method includes a fifth step to execute a set of actions based on the detection of the one or more faults and analyzed first set of data. The first set of data is received from a plurality of sensors installed at different locations in a facility and the plurality of equipment inside the facility. The one or more pre-defined set of rules are obtained from a rules engine. The rules engine stores the one or more pre-defined set of rules in a database. The first set of data are stored on the database in real time. The facility management system detects the one or more faults. The one or more faults are compared to the first set of data in real time based on one or more logical operations. In addition, the one or more logical operations include if condition, and, or, not, nor, nand. The facility management system executes the set of actions based on the detection of the one or more faults and analyzed first set of data. The set of actions includes changing state of at least one of the plurality of equipment or prioritizing a maintenance task for fixing the one or more faults. The maintenance task is assigned to a maintenance team in real time.

### BRIEF DESCRIPTION OF THE FIGURES

Having thus described the disclosure in general terms, reference will now be made to the accompanying figures, wherein;

FIG. 1 illustrates an interactive computing environment for facility management in a building, in accordance with various embodiments of the present disclosure;

FIG. 2 illustrates a flowchart of the method for facility management in the building, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

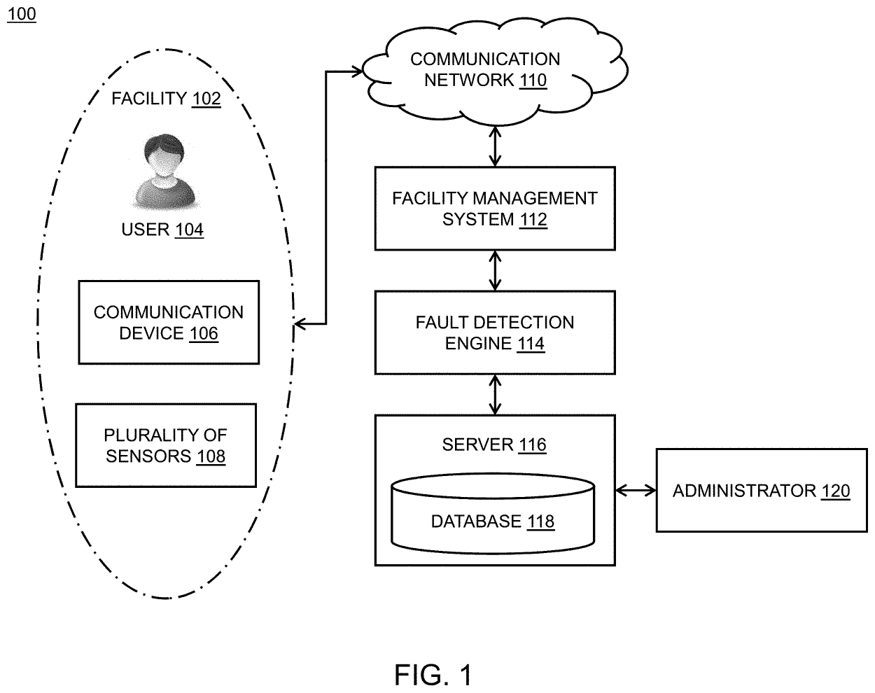

FIG. 1 illustrates an interactive computing environment 100 for management of operations in a facility, in accordance with various embodiments of the present disclosure. The interactive computing environment 100 includes a facility 102, at least one user 104, a communication device 106, a plurality of sensors 108 and a communication network 110. In addition, the interactive computing environment 100 includes a facility management system 112, a fault detection engine 114, a server 116, a database 118 and an administrator 120. The above-stated elements of the interactive computing environment 100 operate coherently and synchronously. The facility management system 112 monitors and controls various functionality of the facility 102. The facility management system 112 allows the user 104 to edit one or more pre-defined set of rules. In addition, the facility management system 112 provides feedback to the user 104 in real time.

The interactive computing environment 100 includes the facility 102. In general, facility is referred to as a building, pieces of equipment, or services that are provided for a particular purpose. In an embodiment of the present disclosure, the facility 102 is any building where people come for events. In another embodiment of the present disclosure, the facility 102 is any place where various equipment is installed and working simultaneously to condition the place. In yet another embodiment of the present disclosure, the facility 102 is any place where the facility management system 112 is installed. In yet another embodiment of the present disclosure, the facility 102 is any place where the fault detection engine 114 is installed. In an example, the facility 102 includes commercial buildings, residential buildings and the like.

The interactive computing environment 100 is associated with the user 104. In an embodiment of the present disclosure, the user 104 is any person who wants to manage a plurality of equipment and the plurality of sensors 108 installed in the facility 102. In another embodiment of the present disclosure, the user 104 is any person who has the authority to manage the plurality of equipment and the plurality of sensors 108 installed in the facility 102. In yet another embodiment of the present disclosure, the user 104 is any person who is a guest in the facility 102. In yet another embodiment of the present disclosure, the user 104 is any person who is a staff member of the facility 102. In yet another embodiment of the present disclosure, the user 104 is any person from a maintenance team. The maintenance team is responsible for repairing and maintaining the plurality of sensors 108 installed in the facility 102. In yet another embodiment of the present disclosure, the user 104 is any person who wants to know the status and output of the fault detection engine 114. In yet another embodiment of the present disclosure, the user 104 is any person who is managing an event in the facility 102. In yet embodiment of the present disclosure, the user 104 is any person who has the knowledge to operate the fault detection engine 114. In yet another embodiment of the present disclosure, the user 104 may be any person. The user 104 may interact with the fault detection engine 114 directly through the communication device 106. The user 104 may interact with the fault detection engine 114 via the communication device 106 through the communication network 110. In this scenario, the communication network 110 may be a global network of computing devices such as the Internet.

The interactive computing environment 100 includes the communication device 106. In general, communication device refers to an equipment device capable of transmitting analog or digital signals through communication wire or remote way. The best case of the communication device is a PC modem, which is equipped for sending and getting analog or digital signals to enable PCs to converse with different PCs. In an embodiment of the present disclosure, the communication device 106 includes but may not be limited to a computer, laptop, smart television, electronic tablet, smartphone, wearable devices, tablet, smartwatch, smart display, gesture-controlled devices, and the like. The communication device 106 displays, reads, transmits and gives output to the user 104 in real time. In another embodiment of the present disclosure, the communication device 106 reads or scans user-defined rules and a user inputs in real time.

In an embodiment of the present disclosure, the communication device 106 is connected to the facility management system 112 with the facilitation of the communication network 110. In another embodiment of the present disclosure, the communication device 106 is connected to the fault detection engine 114 with the facilitation of the communication network 110. In general, communication network refers to channels of communication (networks by which information flows), small networks, which are used for connection to the subgroup and are usually contained in a piece of equipment. The local area network, or LAN, cable or fiber, is used to connect computer equipment and other terminals distributed in the local area, such as in the college campus. The Metropolitan Area Network or MAN is a high-speed network that is used to connect a small geographical area such as a LAN across the city. Wide area networks, or any communication connections, including WAN, microwave radio link and satellite, are used to connect computers and other terminals to a larger geographic distance. In yet another embodiment of the present disclosure, the communication network 110 may be any type of network that provides internet connectivity to the facility management system 112 and the fault detection engine 114. In yet embodiment of the present disclosure, the communication network 110 is a wireless mobile network. In yet embodiment of the present disclosure, the communication network 110 is a wired network with a finite bandwidth. In yet another embodiment of the present disclosure, the communication network 110 is combination of the wireless and the wired network for optimum throughput of data transmission. In yet another embodiment of the present disclosure, the communication network 110 is an optical fiber high bandwidth network that enables high data rate with negligible connection drops. In yet another embodiment of the present disclosure, the communication network 110 provides medium for the communication device 106 to connect to the facility management system 112 and the fault detection engine 114.

The interactive computing environment 100 includes the facility management system 112. The facility management system 112 facilitates the user 104 to control various functionality of the plurality of equipment installed in the facility 102 in real time. In an embodiment of the present disclosure, the facility management system 112 is accessed through a web browser. In another embodiment of the present disclosure, the facility management system 112 is accessed through a widget, API, web applets and the like. In an example, the web-browser includes but may not be limited to Opera, Mozilla Firefox, Google Chrome, Internet Explorer, Microsoft Edge, Safari and UC Browser. Further, the web browser runs on any version of the respective web browser of the above-mentioned web browsers.

Further, the facility management system 112 performs computing operations based on a suitable operating system installed inside the facility management system 112. In general, the operating system is system software that manages computer hardware and software resources and provides common services for computer programs. In addition, the operating system acts as an interface for software installed inside the facility management system 112 to interact with hardware components of the facility management system 112. In an embodiment of the present disclosure, the operating system installed inside the facility management system 112 is a mobile operating system. In an embodiment of the present disclosure, the facility management system 112 performs computing operations based on any suitable operating system designed for portable the facility management system 112. In an example, the mobile operating system includes but may not be limited to Windows operating system from Microsoft, Android operating system from Google, iOS operating system from Apple, Symbian operating system from Nokia, Bada operating system from Samsung Electronics and BlackBerry operating system from BlackBerry. However, the operating system is not limited to above mentioned operating systems. In an embodiment of the present disclosure, the facility management system 112 operates on any version of a particular operating system of above-mentioned operating systems.

In another embodiment of the present disclosure, the facility management system 112 performs computing operations based on any suitable operating system designed for controlling and managing the plurality of equipment and the plurality of sensors 108. In an example, the operating system installed inside the facility management system 112 is Windows from Microsoft. In another example, the operating system installed inside the facility management system 112 is Mac from Apple. In yet another example, the operating system installed inside the facility management system 112 is a Linux based operating system. In yet another example, the operating system installed inside the facility management system 112 may be one of UNIX, Kali Linux, and the like. However, the operating system is not limited to above mentioned operating systems.

In an embodiment of the present disclosure, the facility management system 112 operates on any version of Windows operating system. In another embodiment of the present disclosure, the facility management system 112 operates on any version of Mac operating system. In another embodiment of the present disclosure, the facility management system 112 operates on any version of the Linux operating system. In yet another embodiment of the present disclosure, the facility management system 112 operates on any version of a particular operating system of the above-mentioned operating systems.

The interactive computing environment 100 includes the plurality of sensors 108. In general, sensors are referred to as a device that detects and measures conversion of energy based on physical parameters or processes, and converts real-world information into electrical signals. The sensors are usually used to understand or detect some of the features of your environment. In an embodiment of the present disclosure, the plurality of sensors 108 provides information related to ambient parameters. The plurality of sensors 108 includes a temperature sensor, a humidity sensor, a pressure sensor, a sound sensor, a vibration sensor, a touch sensor, a proximity sensor, an IR sensor, light sensor, air quality index sensor, and the like. In another embodiment of the present disclosure, the plurality of sensors 108 are smart sensors installed at various locations in the facility 102. In yet another embodiment of the present disclosure, the plurality of sensors 108 are IOT based connected sensors. In yet another embodiment of the present disclosure, the plurality of sensors 108 include but may not be limited to location sensors, temperature sensors, alarm sensors, motion sensors, and biometric sensors. In addition, the plurality of sensors 108 generates a computer readable signal. The computer readable signal is termed as a first set of data. The first set of data is sensor data received from the plurality of sensors 108 and the plurality of equipment. In general, sensor data is referred to as the output of a device that detects some kind of input from the physical environment and reacts. Output can be used to provide information or input to any other system or to direct a process. The first set of data includes but may not limit to temperature, lighting settings, humidity, and air quality index.

The interactive computing environment 100 includes the fault detection engine 114. The fault detection engine 114 acts upon the one or more equipment and the plurality of sensors 108 (e.g., Heating ventilation and air conditioning) and produces the first set of data during operation. The first set of data indicates whether the one or more equipment and the plurality of sensors 108 are operating in a normal state or a faulty state. The one or more equipment and the plurality of sensors 108 operate in the faulty state only when there is a problem with the one or more equipment and the plurality of sensors 108.

Further, the fault detection engine 114 receives the first set of data and uses the first set of data to determine whether the one or more equipment and the plurality of sensors 108 is operating in the normal state or the faulty state. When the one or more equipment and the plurality of sensors 108 is operating in the faulty state, the fault detection engine 114 generates alarm ticket to a maintenance team. In general, the maintenance team is responsible for servicing and maintaining the one or more equipment and the plurality of sensors 108 installed in the facility 102.

The interactive computing environment 100 includes the server 116. In an embodiment of the present disclosure, the facility management system 112 is associated with the server 116. In another embodiment of the present disclosure, the fault detection engine 114 is associated with the server 116. In yet another embodiment of the present disclosure, the facility management system 112 is installed at the server 116. In yet another embodiment of the present disclosure, the facility management system 112 is installed at a plurality of servers. In general, server refers to a computer that provides data to other computers. It may serve data to systems on a local area network (LAN) or a wide area network (WAN) over the Internet. Many types of servers exist, including web servers, mail servers, file servers, and the like. Each type of server runs software specific to the purpose of the server. For example, a Web server may run Apache HTTP Server or Microsoft IIS, which both provide access to websites over the Internet. A mail server may run a program like Exim or iMail, which provides SMTP services for sending and receiving email. A file server might use Samba or the operating system's built-in file sharing services to share files over a network. While server software is specific to the type of server, the hardware is not as important. In fact, a regular desktop computer can be turned into a server by adding the appropriate software. For example, a computer connected to a home network can be designated as a file server, print server, or both. In another example, the plurality of servers may include a database server, file server, application server and the like. The plurality of servers communicates with each other using the communication network 110. In yet another embodiment of the present disclosure, the facility management system 112 is located in the server 116. In yet another embodiment of the present disclosure, the facility management system 112 is connected with the server 116. In yet another embodiment of the present disclosure, the server 116 is a part of the facility management system 112. In an embodiment of the present disclosure, the server 116 receives data from the database 118.

The interactive computing environment 100 includes the database 118. In general, database refers to a data structure that stores organized information. Most databases contain multiple tables, which may each include several different fields. For example, a facility database may include tables for reservation records, bill records, dishes, staff, and rooms. Each of these tables would have different fields that are relevant to the information stored in the table. The database 118 stores the one or more pre-defined set of rules, a rules engine, and the first set of data.

Further, the database 118 includes the rules engine. The rules engine is a system that executes one or more pre-defined set of rules in the interactive computing environment 100. The rules engine can control the parameters of the plurality of equipment and the plurality of sensors 108 when the rules engine processes command input by the user 104. In addition, the rules engine transmits commands to the facility management system 112. Furthermore, the rules engine includes the one or more pre-defined set of rules 118. The one or more pre-defined set of rules includes predetermined parameters related to the facility 102. Moreover, the predetermined parameters include but may not be limited to default temperature, default humidity, default air quality index, default lighting, and default air flow rate, default pressure, default VFD speed, default differential pressure, default vibration, default valve position, and the like. The one or more pre-defined set of rules are a set of rules that helps to break down complex processes into simple, and repetitive steps.

The interactive computing environment 100 is associated with the administrator 120. The administrator 120 is any person or individual who monitors the working of the facility management system 112 and the fault detection engine 114 in real time. The administrator 120 monitors the facility management system 112 and the fault detection engine 114 through the communication device 106. In an example, the administrator 120 has the authority to change the one or more pre-defined set of rules anytime with the facilitation of the communication device 106

In an embodiment of the present disclosure, the facility management system 112 controls various functionality of the plurality of equipment installed in the facility 102 in real time. In another embodiment of the present disclosure, the facility management system 112 controls various functionality of the plurality of sensors 108 installed in the facility 102 in real time. The facility management system 112 receives the first set of data form the plurality of sensors 108 installed at different locations in the facility 102 and the plurality of equipment inside the facility 102. The plurality of sensors 108 are installed at different locations in the facility 102. In an example, the plurality of sensors 108 are installed outside of various rooms, entrance gate of the facility 102, and the like. In yet another embodiment of the present disclosure, the plurality of sensors 108 are installed near the plurality of equipment. The plurality of equipment is installed at various locations of the facility 102. The plurality of equipment are devices used in the facility 102 to make work organized and comfortable. The plurality of equipment includes heating ventilation and air conditioning, facility lighting, intercom system, power system, fire system, security system, and the like.

In an embodiment of the present disclosure, the facility management system 112 obtains the one or more pre-defined set of rules from the rules engine. In another embodiment of the present disclosure, the one or more pre-defined set of rules are set by the administrator 120. In yet another embodiment of the present disclosure, the one or more pre-defined set of rules is managed by the rules engine. In yet another embodiment of the present disclosure, the rules engine stores the one or more pre-defined set of rules on the database 118. In yet another embodiment of the present disclosure, the user 104 makes a user input on the communication device 106. Further, the first set of data is received from the plurality of the sensors 108. The first set of data is transferred to the facility management system 112. The facility management analyses the first set of data based on the one or more pre-defined set of rules.

Further, the user 104 can optimize the one or more pre-defined set of rules termed as user-defined rules. In an embodiment of the present disclosure, the user-defined rules are custom rules of the one or more pre-defined set of rules. The user-defined rules are based on the user inputs. The user inputs are recorded on the communication device 106. Furthermore, the facility management system 112 provides feedback to the user 104 about the status of the user input in real time. In an example, when an event is organized in a building, the user 104 can change the settings of the various equipment and sensors based on a number of guests in that event.

In an embodiment of the present disclosure, the fault detection engine 114 detects the one or more faults in the plurality of sensors 108 and the plurality of equipment. In addition, the one or more faults are compared to the first set of data in real time based on one or more logical operations. The one or more logical operations include if conditions, AND, OR, NOT, NAND, NOR. In addition, the past set of fault data are stored on the database 118. In an embodiment of the present disclosure, the fault detection engine 114 identifies the cause of the one or more faults. Further, the facility management system 112 executes a set of actions based on the detection of the one or more faults and the analyzed first set of data. The set of actions include real time change of state of at least one of the plurality of equipment or prioritizing a maintenance task for fixing the one or more faults. In an embodiment of the present disclosure, the fault detection engine 114 triggers an alarm based on the change of state. The fault detection engine 114 monitors the change of state in real time. The change of state is either greater than threshold value set by the pre-defined set of rules or lower than the threshold value set by the pre-defined set of rules. In an example, the fault detection engine 114 triggers the alarm when there is a sudden increase in the default temperature in the chiller and the temperature outside the chiller is decreasing. Further, the fault detection engine 114 diagnoses prime cause of the alarm raised based on the past set of fault data in real time. In an example, a fire alarm system starts buzzing. The fault detection engine 114 diagnoses the prime cause or reason behind the buzzing of the fire alarm system.

In addition, the fault detection engine 114 prioritizes a maintenance task for fixing the one or more faults based on the urgency of the plurality of the equipment. The maintenance task is assigned to a maintenance team in real time. The fault detection engine 114 predicts an estimated maintenance time for the one or more faults in real time. The estimated maintenance time is predicted based on the past set of fault data stored on the database 118. Moreover, the fault detection engine 114 identifies and detects potential solutions for the prime cause or reason related to triggering of the alarm to the maintenance team in real time. Moreover, the fault detection engine 114 features a state identifier. The state identifier determines status of the fault detection engine 114. The state identifier intimates about the status of the fault detection engine 114 to the user 104 and the administrator 120 on the communication device 106 in real time.

In addition, the facility management system 112 has ability to determine and identify probability of occurrence of the one or more faults in the plurality of equipment. In an embodiment of the present disclosure, the facility management system 112 determines and identifies the probability of occurrence of the one or more faults based on one or more machine learning algorithms. In another embodiment the facility management system 112 displays the probability of occurrence of faults in the plurality of equipment to the user 104 on the communication device 106. The facility management system 112 also determines to identify maximum possibilities of an event of fault. In an example, the building is installed with the plurality of equipment and plurality of sensor. The facility management system 112 of the building determines and identifies the probability of occurrence of the one or more faults in the plurality of equipment and plurality of sensor that are placed inside the building.

In an embodiment of the present disclosure, the facility management system 112 calculates impact of the anomalous behavior of the plurality of equipment installed in the facility 102 using the fault detection system 114. In an embodiment of the present disclosure, the facility management system 112 also calculates the impact associated with an event of fault in equipment in real time in order to save energy. In an example, heating ventilation and air conditioner system has temperature higher than the temperature of atmosphere outside. In addition, the facility management system 112 is able to calculate the impact associated with the anomalous behavior or an event of fault in an equipment in order to save energy and resist the heating ventilation and air conditioner system from wasting energy.

In an embodiment of the present disclosure, the facility management system 112 notifies the user 104 in real time. In an embodiment of the present disclosure, the facility management system 112 notifies the user 104 to provide command to control the plurality of equipment. The facility management system 112 notifies the user 104 to give command to the plurality of equipment based on the user defined rules or anomalous behavior of the plurality of equipment. In general, user defined rules are the rules that are defined by the user. In addition, user defined rules are the rules that are made or created by the user. In an example, the user 104 is able to lower down the temperature of the heating ventilation and air conditioner equipment. In addition, the temperature of heating ventilation and air conditioner equipment is set to a higher level. The user 104 is able to lower down the temperature of the heating ventilation and air conditioner equipment if the temperature of outside atmosphere is higher so as to save energy sources.

In addition, the facility management system 112 provides analytical report of performance to the user 104. In an embodiment of the present disclosure, the facility management system 112 enables the user 104 to receive the analytical report of the performance of the plurality of equipment. In addition, the user 104 receives the analytical report of the performance of the plurality of equipment on monthly basis criteria. In addition, the user 104 uses the user defined rules to receive the analytical report of the performance of the plurality of equipment. In another embodiment of the present disclosure, the facility management system 112 provides the analytical report over one or more platforms. The one or more platforms include e-mails, communication device and the like. In an example, heating ventilation and air conditioner is not working properly. The facility management system 112 enables the user 104 to receive the analytical report of the performance of the heating ventilation and air conditioner system.

In addition, the facility management system 112 activates one or more rules among the one or more pre-defined set of rules. In an embodiment of the present disclosure, the facility management system 112 activates the one or more rules among the pre-defined set of rules based on one or more pre-requisite conditions in real time. In addition, the facility management system 112 automatically activates the one or more rule among the one or more pre-defined set of rules that examine that either another rules are working accurately or not. In an example, the facility management system 112 examines that which section of facility 102 has huge amount of occupants and simultaneously activates rule for the heating ventilation and air conditioner system to lower down the temperature of the chiller so as to provide more comfort and better air quality in respected section of the facility 102.

In an embodiment of the present disclosure, the fault detection engine 114 detects the one or more faults. In addition, the user 104 define rules for the one or more faults using the rule engine. In addition, the rule engine interacts with the one or more faults. In addition the rule engine resolves the one or more faults that does not require any sort of action based on the rules that is defined by the user 104 in real time. In an example, the user 104 has set rules for the HVAC system to maintain the room temperature to 20° C. that is threshold value. In addition, the HVAC system lowers down the room temperature to threshold value and simultaneously, the HVAC system turns off itself and notifies the user 104 that the temperature has reached to threshold value so as to prevent over cooling of the room and save energy.

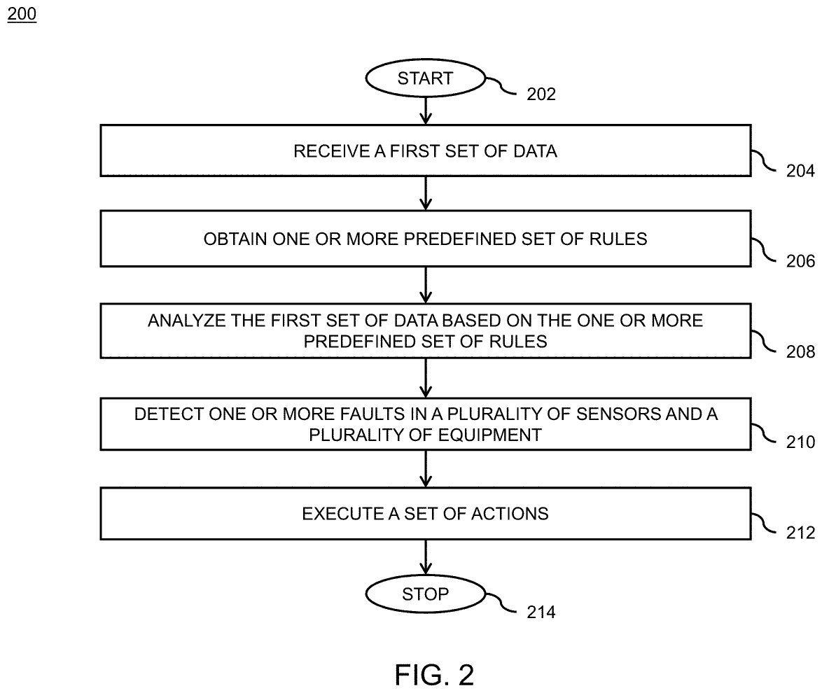

FIG. 2 illustrates a flowchart 200 of the method for facility management in the building, in accordance with various embodiments of the present disclosure. It may be noted that in order to explain the method steps of the flowchart 200, references will be made to the elements explained in FIG. 1. The flowchart 200 starts at step 202. At step 204, the facility management system 112 receives the first set of data. At step 206, the facility management system 112 obtains the one or more pre-defined set of rules. At step 208, the facility management system 112 analyzes the first set of data based on the one or more pre-defined set of rules. At step 210, the facility management system 112 detects the one or more faults in the plurality of sensors 108 and the plurality of equipment. At step 212, the facility management system 112 executes the set of actions. The flow chart 200 terminates at step 214.

It may be noted that the flowchart 200 is explained to have above stated process steps; however, those skilled in the art would appreciate that the flowchart 200 may have more/less number of process steps which may enable all the above stated embodiments of the present disclosure.

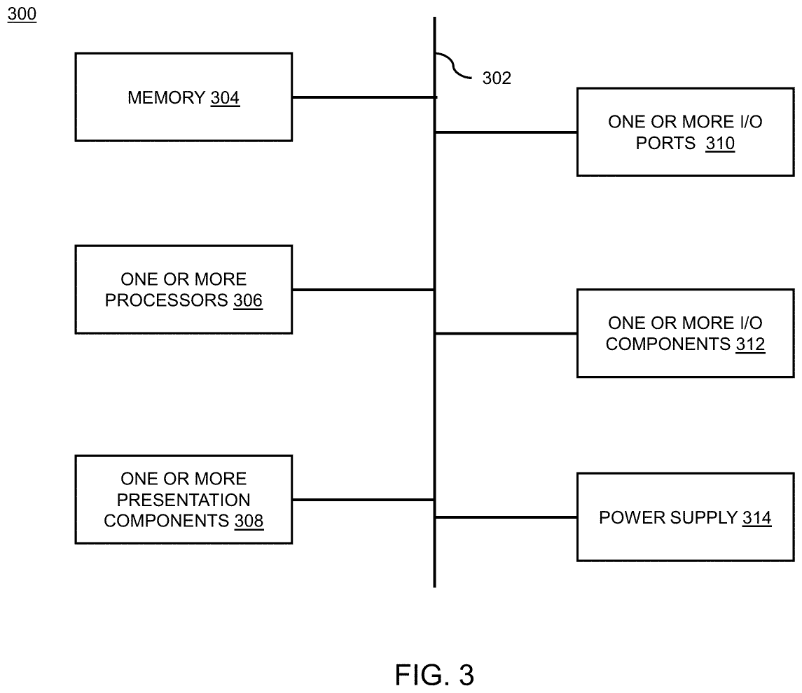

FIG. 3 illustrates a block diagram of a computing device 300, in accordance with various embodiments of the present disclosure. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and non-volatile media, removable and non-removable media. By way of example, and not limitation, the computer-readable media may comprise computer storage media and communication media. The computer storage media includes volatile and non-volatile, removable and non-removable media implemented in any method or technology for storage of information such as computer-readable instructions, data structures, program modules or other data. The computer storage media includes, but is not limited to, non-transitory computer-readable storage medium that stores program code and/or data for short periods of time such as register memory, processor cache and random access memory (RAM), or any other medium which can be used to store the desired information and which can be accessed by the computing device 300. The computer storage media includes, but is not limited to, non-transitory computer readable storage medium that stores program code and/or data for longer periods of time, such as secondary or persistent long term storage, like read-only memory (ROM), EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or non-volatile memory. The memory 304 may be removable, non-removable, or a combination thereof. Exemplary hardware devices include solid-state memory, hard drives, optical-disc drives, etc. The computing device 300 includes the one or more processors 306 that read data from various entities such as memory 304 or I/O components 312. The one or more presentation components 308 present data indications to the user 102 or another device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The foregoing descriptions of pre-defined embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed:

1. A computer-implemented method for providing management of operations in a facility based on user-defined rules, the computer-implemented method comprising:
receiving, at a facility management system with a processor, a first set of data, wherein the first set of data is received from a plurality of sensors installed at different locations in the facility and a plurality of equipment inside the facility;
obtaining, at the facility management system with the processor, one or more pre-defined set of rules, wherein the one or more pre-defined set of rules are obtained from a rules engine, wherein the rules engine stores the one or more pre-defined set of rules in a database;
analyzing, at the facility management system with the processor, the first set of data based on the one or more pre-defined set of rules, wherein the first set of data is stored in the database in real time;
detecting, at the facility management system with the processor, one or more faults in the plurality of sensors and the plurality of equipment, wherein the facility management system detects the one or more faults, wherein the one or more faults are compared to the first set of data in real time based on one or more logical operations, wherein the one or more logical operations comprising if condition, and, or, nand, nor, xor; and
executing, at the facility management system with the processor, a set of actions, wherein the facility management system executes the set of actions based on the detection of the one or more faults and the analyzed first set of data, wherein the set of actions comprising changing state of at least one of the plurality of equipment or prioritizing a maintenance task for fixing the one or more faults, wherein the maintenance task is assigned to a maintenance team in real time.

2. The computer-implemented method as recited in claim 1, wherein the first set of data comprising environment data, safety system data, electrical system data, electronic system data, wherein the environmental data comprising temperature, atmospheric pressure, precipitation, humidity, and air quality index.

3. The computer-implemented method as recited in claim 1, wherein the plurality of equipment comprising heating ventilation and air conditioning, facility lighting, intercom system, power system, fire system, and security system.

4. The computer-implemented method as recited in claim 1, further comprising providing, at the facility management system with the processor, feedback to a user through a communication device, wherein the communication device comprising a smartphone, a laptop, a smartwatch, a tablet, and a smart display.

5. The computer-implemented method as recited in claim 1, wherein the plurality of sensors comprising temperature sensor, smoke sensor, thermal sensor, motion sensor, proximity sensor, optical sensor, light sensor, panic sensor, fire alarm, air quality index sensor and humidity sensor.

6. The computer-implemented method as recited in claim 1, wherein a fault detection engine predicts an estimated maintenance time for the one or more faults in real time, wherein the estimated maintenance time is predicted based on a past set of fault data.

7. The computer-implemented method as recited in claim 1, further comprising a state identifier, wherein the state identifier determines status of a fault detection engine in real time.

8. The computer-implemented method as recited in claim 1, wherein the one or more pre-defined set of rules comprising predetermined parameters related to the facility, wherein the predetermined parameters comprising default temperature, default humidity, default air quality index, default lighting, and default air flow rate, default pressure, default VFD speed, default differential pressure, default vibration and default valve position.

9. The computer-implemented method as recited in claim 1, further comprising user-defined rules, wherein the user-defined rules are custom rules of the one or more pre-defined set of rules, wherein the one or more pre-defined set of rules can be optimized by the user in real time.

10. The computer-implemented method as recited in claim 9, wherein the user-defined rules are based on user inputs, wherein the user inputs are recorded on a communication device in real time.

11. The computer-implemented method as recited in claim 1, further comprising determining, at the facility management system with the processor, probability of occurrence of the one or more faults, wherein the facility management system determines and identifies the probability of occurrence of the one or more faults in the plurality of equipment based on past data associated with the plurality of equipment and displays the probability to the user on a communication device.

12. The computer-implemented method as recited in claim 1, further comprising calculating, at the facility management system with the processor, impact of anomalous behavior of the plurality of equipment, wherein the facility management system calculates the impact of the anomalous behavior of the plurality of equipment using the fault detection system in real time in order to save energy.

13. The computer-implemented method as recited in claim 1, further comprising notifying, at the facility management system with the processor, the user in real time, wherein the facility management system notifies the user to give command to control the plurality of equipment based on user defined rules or anomalous behavior of the plurality of equipment.

14. The computer-implemented method as recited in claim 1, further comprising activating, at the facility management system with the processor, one or more rules, wherein the facility management system activates one or more rules among the one or more pre-defined set of rules based one or more on pre-requisite conditions in real time.

15. A computer system comprising:
one or more processors; and
a memory coupled to the one or more processors, the memory for storing instructions which, when executed by the one or more processors, cause the one or more processors to perform a method for providing management of operations in a facility based on user-defined rules, the method comprising:
receiving, at a facility management system, a first set of data, wherein the first set of data is received from a plurality of sensors installed at different locations in the facility and a plurality of equipment inside the facility;
obtaining, at the facility management system, one or more pre-defined set of rules, wherein the one or more pre-defined set of rules are obtained from a rules engine, wherein the rules engine stores the one or more pre-defined set of rules in a database;
analyzing, at the facility management system, the first set of data based on the one or more pre-defined set of rules, wherein the first set of data is stored in the database in real time;
detecting, at the facility management system, one or more faults in the plurality of sensors and the plurality of equipment, wherein the facility management system detects the one or more faults, wherein the one or more faults are compared to the first set of data in real time based on one or more logical operations wherein the one or more logical operations comprising if condition, and, or, nand, nor, xor; and
executing, at the facility management system, a set of actions, wherein the facility management system executes the set of actions based on the detection of the one or more faults and the analyzed first set of data, wherein the set of actions comprising changing state of at least one of the plurality of equipment or prioritizing a maintenance task for fixing the one or more faults, wherein the maintenance task is assigned to a maintenance team in real time.

16. The computer system as recited in claim 15, wherein the first set of data comprising environment data, safety system data, electrical system data, electronic system data, wherein the environmental data comprising temperature, atmospheric pressure, precipitation, humidity, and air quality index.

17. The computer system as recited in claim 15, wherein the plurality of equipment comprising heating ventilation and air conditioning, facility lighting, intercom system, power system, fire system, and security system.

18. The computer system as recited in claim 15, further comprising providing, at the facility management system, feedback to a user through a communication device, wherein the communication device comprising a smartphone, a laptop, a smartwatch, a tablet, and a smart display.

19. The computer system as recited in claim 15, wherein the plurality of sensors comprising temperature sensor, smoke sensor, thermal sensor, motion sensor, proximity sensor, optical sensor, light sensor, panic sensor, fire alarm, air quality index sensor and humidity sensor.

20. A non-transitory computer-readable storage medium encoding computer executable instructions that, when executed by at least one processor, performs a method for providing management of operations in a facility based on user-defined rules, the method comprising:
receiving, at a computing device, a first set of data, wherein the first set of data is received from a plurality of sensors installed at different locations in the facility and a plurality of equipment inside the facility;
obtaining, at the computing device, one or more pre-defined set of rules, wherein the one or more pre-defined set of rules are obtained from a rules engine, wherein the rules engine stores the one or more pre-defined set of rules in a database;
analyzing, at the computing device, the first set of data based on the one or more pre-defined set of rules, wherein the first set of data is stored in the database in real time;
detecting, at the computing device, one or more faults in the plurality of sensors and the plurality of equipment, wherein the facility management system detects the one or more faults, wherein the one or more faults are compared to the first set of data in real time based on one or more logical operations wherein the one or more logical operations comprising if condition, and, or, nand, nor, xor; and
executing, at the computing device, a set of actions, wherein the facility management system executes the set of actions based on the detection of the one or more faults and analyzed first set of data, wherein the set of actions comprising changing state of at least one of the plurality of equipment or prioritizing a maintenance task for fixing the one or more faults, wherein the maintenance task is assigned to a maintenance team in real time.
